(19) United States
(12) Patent Application Publication
(10) Pub. No.: US 2026/0067254 A1
(43) Pub. Date: Mar. 5, 2026

(54) ACTIVE DNS PROXY

(71) Applicant: Palo Alto Networks, Inc., Santa Clara, CA (US)

(72) Inventors: Jia Chen, Palo Alto, CA (US); Tripti Agarwal, Fremont, CA (US); Shraddha Pradeep Bhosale, San Jose, CA (US); Rohit Mendiratta, Dublin, CA (US)

(21) Appl. No.: 18/819,707

(22) Filed: Aug. 29, 2024

(51) Int. Cl. H04L 9/40

(52) U.S. Cl. CPC H04L 63/0281; H04L 63/0236; H04L 63/306

(57) ABSTRACT

At an active Domain Name System (DNS) proxy, an Internet Protocol version 6 (IPv6) DNS request from a client is received. It is determined that security inspection of Internet Protocol version 6 (IPv6) is not supported by a security service node. An Internet Protocol version 4 (IPv4) address is obtained and provided in response to the IPv6 DNS request.

### BACKGROUND OF THE INVENTION

An Internet Protocol (IP) address is assigned to a device on a computer network. The widely used IP Version 4 (IPv4) allows 4.3 billion unique addresses. However, the newest IP Version 6 (IPv6) allows over a thousand times more addresses using hexadecimal numbers. However, many legacy servers and services do not fully support IPv6. Therefore, there exists a need to support legacy IPv4 servers and services in an IPv6 environment.

### BRIEF DESCRIPTION OF THE DRAWINGS

Various embodiments of the invention are disclosed in the following detailed description and the accompanying drawings.

FIG. 1 is a diagram illustrating an example of a cloud security solution at a security service node having a limited support for IPv6 traffic.

FIG. 2 is a diagram illustrating an example of a cloud security solution at a security service node using a DNS proxy transformation to overcome limited support for IPv6.

FIG. 3 is a diagram illustrating another example of a cloud security solution at a security service node using a DNS proxy transformation to overcome limited support for IPv6.

FIG. 4 is a diagram illustrating an example timeline of a network traffic pattern using a security service node having limited support for IPv6 traffic.

FIG. 5 is a diagram illustrating an example timeline for a cloud security solution at a security service node using a DNS proxy transformation to overcome limited support for IPv6.

FIG. 6 is a flow diagram illustrating an embodiment for handling a DNS request for a protocol not supported for security inspection.

FIG. 7 is a functional diagram illustrating a programmed computer system for an active DNS proxy.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A firewall protects networks from unauthorized access while permitting authorized communications to pass through the firewall. A firewall can be implemented as a device, a set of devices, or software executed on a device that provides a firewall function for network access. For example, a firewall can be integrated into operating systems of devices (e.g., computers, smart phones, or other types of network communication capable devices). A firewall can also be integrated into or executed as one or more software applications on various types of devices, such as computer servers, gateways, network/routing devices (e.g., network routers), and data appliances (e.g., security appliances or other types of special purpose devices), and in various implementations, certain operations can be implemented in special purpose hardware, such as an ASIC or FPGA.

Firewalls may deny or permit network transmission based on a set of rules. These sets of rules are often referred to as policies (e.g., network policies or network security policies). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as are described herein). A firewall can also filter local network (e.g., intranet) traffic by similarly applying a set of rules or policies.

Security devices (e.g., security appliances, security gateways, security services, and/or other security devices) can include various security functions (e.g., firewall, anti-malware, intrusion prevention/detection, Data Loss Prevention (DLP), and/or other security functions), networking functions (e.g., routing, Quality of Service (QoS), workload balancing of network related resources, and/or other networking functions), and/or other functions. For example, routing functions can be based on source information (e.g., IP address and port), destination information (e.g., IP address and port), and protocol information.

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform state-based packet inspection in which each packet is examined within the context of a series of packets associated with that network transmission's flow of packets. This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content (e.g., next generation firewalls). In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series firewalls). For example, Palo Alto Networks' next generation firewalls enable enterprises to identify and control applications, users, and content—not just ports, IP addresses, and packets—using various identification technologies, such as the following: APP-ID for accurate application identification, User-ID for user identification (e.g., by user or user group), and Content-ID for real-time content scanning (e.g., controlling web surfing and limiting data and file transfers). These identification technologies allow enterprises to securely enable application usage using business-relevant concepts, instead of following the traditional approach offered by traditional port-blocking firewalls. Also, special purpose hardware for next generation firewalls (implemented, for example, as dedicated appliances) generally provides higher performance levels for application inspection than software executed on general purpose hardware (e.g., such as security appliances provided by Palo Alto Networks, Inc., which use dedicated, function specific processing that is tightly integrated with a single-pass software engine to maximize network throughput while minimizing latency).

Advanced or next generation firewalls can also be implemented using virtualized firewalls. Examples of such next generation firewalls are commercially available from Palo Alto Networks, Inc. (e.g., Palo Alto Networks' VM Series firewalls, which support various commercial virtualized environments, including, for example, VMware® ESXi™ and NSX™, Citrix® Netscaler SDX™, KVM/OpenStack (Centos/RHEL, Ubuntu®), and Amazon Web Services (AWS)) as well as CN Series container next generation firewalls. For example, virtualized firewalls can support similar or the exact same next-generation firewall and advanced threat prevention features available in physical form factor appliances, allowing enterprises to safely enable applications flowing into, and across their private, public, and hybrid cloud computing environments. Automation features such as VM monitoring, dynamic address groups, and a REST-based API allow enterprises to proactively monitor VM changes dynamically feeding that context into security policies, thereby eliminating the policy lag that may occur when VMs change.

Active DNS proxy is disclosed. For example, a Domain Name System (DNS) proxy of a security service node contains intelligence that is used to detect the type of DNS request received from a client. In some embodiments, the client is a dual-stack client that sends Internet Protocol version 6 (IPv6) DNS requests but sends IPv4 DNS requests when IPv6 DNS requests fail. The active DNS proxy can detect and determine the Internet Protocol version of the DNS request and the security features of the security service node. The active DNS proxy leverages these detection abilities to reply to the IPv6 DNS request with a corresponding IPv4 address that was either stored in its cache or obtained from a translated IPv4 DNS request when it detects that security inspection of IPv6 data traffic is not supported by the security service node. Early detection of the IPv6 request allows the DNS proxy to appropriately respond to the client without creating security holes and reducing the delay experienced by the user when attempting to connect to the Internet with an unsupported Internet protocol version. By providing the IPv4 address in response to the IPv6 request, whether from a cache or from translating the IPv6 DNS request to an IPv4 DNS request and obtaining the corresponding IPv4 address from a DNS server, the client can connect to the Internet via a connection protected by the IPv4 security service node with minimized delay.

In some embodiments, an Internet protocol version 6 (IPv6) Domain Name System (DNS) request is received from a client at an active DNS proxy. For example, an active DNS proxy of a security service node receives an “AAAA” DNS request. IPv6 DNS requests include “AAAA” DNS requests, and IPv4 DNS requests include “A” DNS requests. In some embodiments, it is determined that security inspection of IPv6 is not supported by a security service node. For example, a cloud security service node has not been configured to support security examination of IPv6 data traffic. In another example, IPv6 services are disabled for a cloud security service node and IPv4 is to be utilized by a client protected by a cloud security service node. An IPv4 address is obtained and provided in response to the IPv6 DNS request. For example, the IPv4 address is stored in the cache of the active DNS proxy from previous queries and is provided to the client. As another example, the active DNS proxy translates the IPv6 DNS request to an IPv4 DNS request, and the IPv4 DNS request is sent to a DNS client. The response of the DNS client, which contains an IPv4 address, is received by the active DNS proxy and provided to the client.

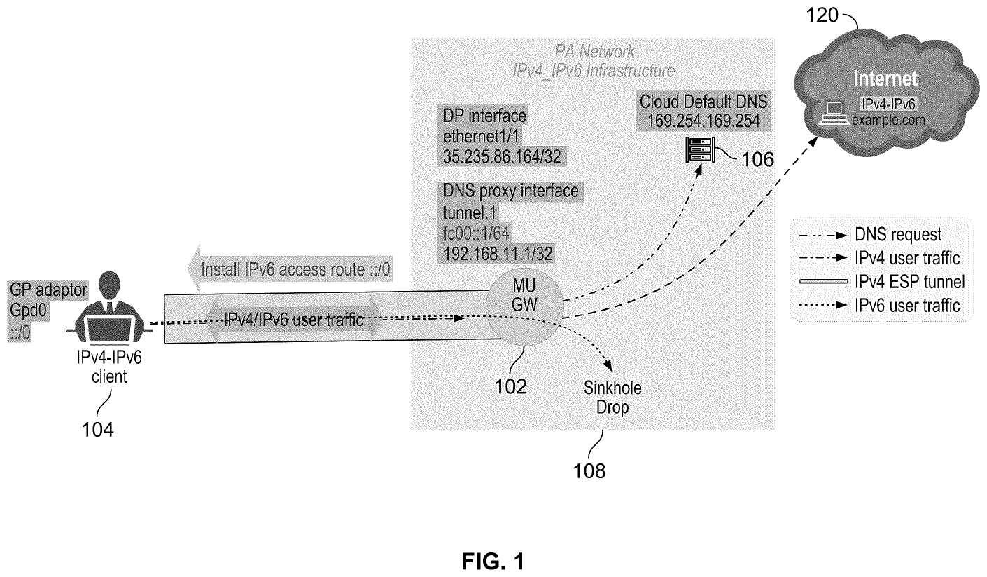

FIG. 1 is a diagram illustrating an example of a cloud security solution at a security service node having a limited support for IPv6 traffic. Referring to FIG. 1, as shown in this example diagram, an IPv4/IPv6 client as shown at 104 is connected to mobile user (MU) gateway (GW) 102. In some embodiments, MU GW 102 includes a DNS proxy. In the example scenario, MU GW 102 is part of a security service node that does not support security examination/screening of IPv6 data traffic, and the IPv4/IPv6 client is a dual-stack client that can send both IPv6 and IPv4 DNS requests.

For existing IPv6 solutions (e.g., as typically implemented by cloud security service providers, such as Prisma Access, which is commercially available from Palo Alto Networks, Inc. (PA), headquartered in Santa Clara, CA, and Internet Service Providers (ISPs)), IPv6 data traffic sent by IPv4/IPv6 client 104 to an Internet server (e.g., example.com) as shown at 120 via MU GW 102 is dropped via sinkhole 108. When MU GW 102 receives an IPv6 “AAAA” DNS request from IPv4/IPv6 client 104, MU GW 102 forwards the “AAAA” DNS request to cloud DNS 106. Cloud DNS 106 responds to MU GW 102 by providing the corresponding IPv6 address to the “AAAA” DNS request, which is sent back to IPv4/IPv6 client 104 via MU GW 102. Once IPv4/IPv6 client 104 receives the IPv6 address, IPv4/IPv6 client 104 can initiate IPv6 data traffic to Internet server 120 (e.g., example.com). MU GW 102 performs secure web gateway and/or firewall functionality by acting as an intermediary that filters and manages web traffic to/from client 104 as well as enforcing security policies by examining network traffic/packets to/from client 104. However, MU GW 102 is not configured to examine IPv6 network traffic/packets. When the IPv6 data traffic from client 104 is sent and reaches MU GW 102, the data packets are dropped via sinkhole 108 and a request is sent to IPv4/IPv6 client 104 to reset the session to force client 104 to retry the communication in IPv4. IPv4/IPv6 Client 104 restarts the session and sends an A DNS request to MU GW 102, which fetches an IPv4 address from cloud DNS 106, and returns the IPv4 address to IPv4/IPv6 client 104. When IPv4/IPv6 client 104 receives the IPv4 address, IPv4/IPv6 client 104 can connect to Internet server (e.g. example.com) 120 via MU GW 102 through the IPv4 address. Any IPv4 data traffic between client 104 and Internet server 120 is filtered and monitored by MU GW 102. Both the IPv6 and IPv4 addresses point to Internet server 120, but only security examination of IPv4 traffic is supported by the security service node, so the IPv4 address is forced to be used.

However, this solution results in a long delay before IPv4/IPv6 client 104 can access Internet server 120. For example, the sinkhole solution to send IPv4 data traffic after IPv6 data traffic fails may lead to IPv4/IPv6 client 104 experiencing delays of a few seconds or longer when connecting to Internet 120 through MU GW 102. Thus, a new and improved solution is needed to address this technical challenge associated with incompatible network settings, such as network connection delays, in addition to providing network security to the client.

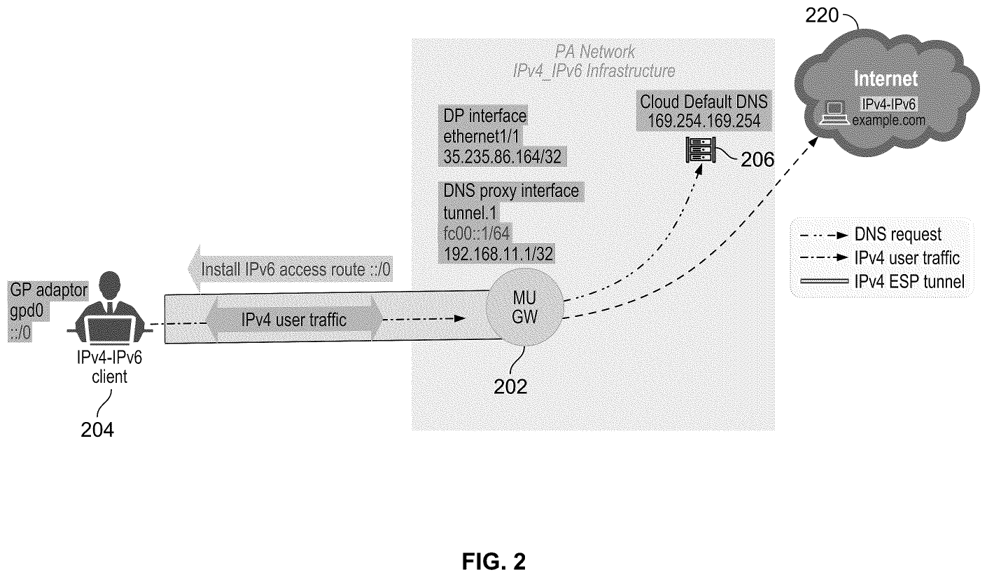

FIG. 2 is a diagram illustrating an example of a cloud security solution at a security service node using a DNS proxy transformation to overcome limited support for IPv6. In some embodiments, the security service node includes a firewall or a secure web gateway that performs security inspections on data traffic that is received. For example, a cloud security service node receives data traffic from IPv4/IPv4/IPv6 client 204 and Internet server 220 and processes the data traffic for malware. MU GW 202 performs secure web gateway and/or firewall functionality by acting as an intermediary that filters and manages web traffic to/from client 204 as well as enforcing security policies by examining network traffic/packets to/from client 204. For example, IPv4/IPv4/IPv6 client 204 connects to Internet server 220 via MU GW 202 that examines network traffic between 204 and Internet server 220 for security issues.

However, MU GW 202 is not configured to examine IPv6 network traffic/packets. In the example shown, MU GW 202 includes a DNS proxy. In some embodiments, IPv4/IPv4/IPv6 client 204 sends an IPv6 “AAAA” DNS request to MU GW 202. MU GW 202 detects that the “AAAA” DNS request from IPv4/IPv4/IPv6 client 204 is for IPv6, an Internet Protocol version not supported for security inspection by the security service node. In some embodiments, determining that IPv6 is not supported by the security service node includes determining that the security service node is configured to drop unsupported IPv6 packets (e.g., to force a packet sender to default back to IPv4). The configuration to drop received IPv6 packets is paired with a configuration to reset the associated IPv6 session to cause an IPv4 session to be initiated instead. These configurations are executed in the existing IPv6 solution described in FIG. 1. Once the IPv6 DNS request is detected, MU GW 202 translates the IPv6 “AAAA” DNS request to an IPv4 “A” DNS request, transforming the request for an IPv6 address to that of an IPv4 address. In some embodiments, the translation from an “AAAA” DNS request to an “A” DNS request is performed by changing the record type in the DNS request from “AAAA” to “A. ” Then, MU GW 202 forwards the translated “A” DNS request to a Domain Name System (DNS) service, such as cloud DNS 206, and receives an IPv4 address (e.g., corresponding to Internet server 220). In some embodiments, the IPv4 address of the translated IPv4 “A” DNS request is obtained from a cache of MU GW 202 and without communication between cloud DNS 206 and MU GW 202. The IPv4 address is sent back to IPv4/IPv4/IPv6 client 204, and IPv4/IPv4/IPv6 client 204 can begin IPv4 data traffic to Internet server 220 using the IPv4 address. The IPv4 data traffic for the IPv4 address is intercepted at the security service node, which performs a security inspection of the IPv4 data traffic before forwarding the IPv4 data traffic to the IPv4 address. As compared to the example discussed along with FIG. 1, the active DNS proxy solution shown in FIG. 2 reduces the number of packets and messages sent among IPv4/IPv4/IPv6 client 204, MU GW 202, and cloud DNS 206 by avoiding the sinkhole failure of IPv6 data traffic by reducing the initial Internet access delay experienced by IPv4/IPv4/IPv6 client 204 by providing an IPv4 address data instead of a requested IPv6 address.

In some embodiments, IPv4/IPv4/IPv6 client 204 is an example client for accessing Internet server 220. For example, IPv4/IPv4/IPv6 client 204 can be a network device such as a desktop computer, a laptop, a tablet, or another network computing device. In some embodiments, IPv4/IPv6 client 204 is a dual-stack client. For example, when connecting to Internet server 220 through MU GW 202, IPv4/IPv6 client 204 sends an IPv6 “AAAA” DNS request. If the “AAAA” DNS request fails, IPv4/IPv6 client 204 will send an IPv4 “A” DNS request. In some embodiments, IPv4/IPv6 client 204 is using an app, website, or software that connects it to MU GW 202 when connecting to the Internet server 220. For example, IPv4/IPv6 client 204 uses an app, website, or software that connects to Internet server 220 through a VPN, gateway, firewall, or cloud service provider.

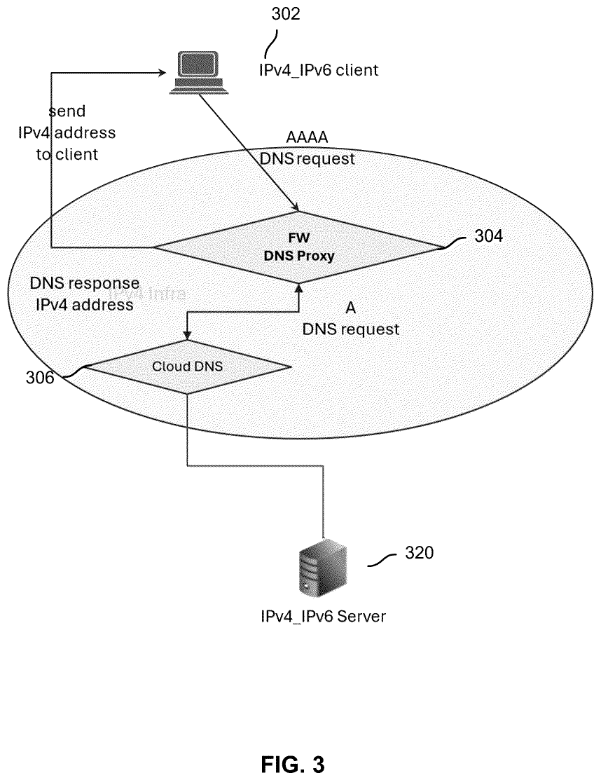

FIG. 3 is a diagram illustrating another example of a cloud security solution at a security service node using a DNS proxy transformation to overcome limited support for IPv6. IPv4/IPv6 client 302 sends an IPv6 “AAAA” DNS request for an IP address of server 320 that is received/intercepted by FW (Firewall) DNS Proxy 304. FW DNS Proxy 304 identifies the DNS request as an IPv6 “AAAA” DNS request and translates the “AAAA” DNS request to an IPv4 “A” DNS request to preemptively avoid the sinkhole case described in conjunction with FIG. 1. The IPv4 “A” DNS request is forwarded to cloud DNS 306, which fetches an IPv4 address corresponding to the “A” DNS request for IPv4/IPv6 server 320. The IPv4 address is provided to IPv4/IPv6 client 302 in response to its IPv6 request via FW DNS Proxy 304, and IPv4/IPv6 client 302 can use the IPv4 address to connect to IPv4/IPv6 server 320. In some embodiments, IPv4/IPv6 server 320 is an Internet server corresponding to a website or public application. In some embodiments, IPv4/IPv6 client 302, FW DNS Proxy 304, cloud DNS 306, and IPv4/IPv6 server 320 are IPv4/IPv6 client 204, MU GW 202, cloud DNS 206, and Internet server 220 of FIG. 2, respectively.

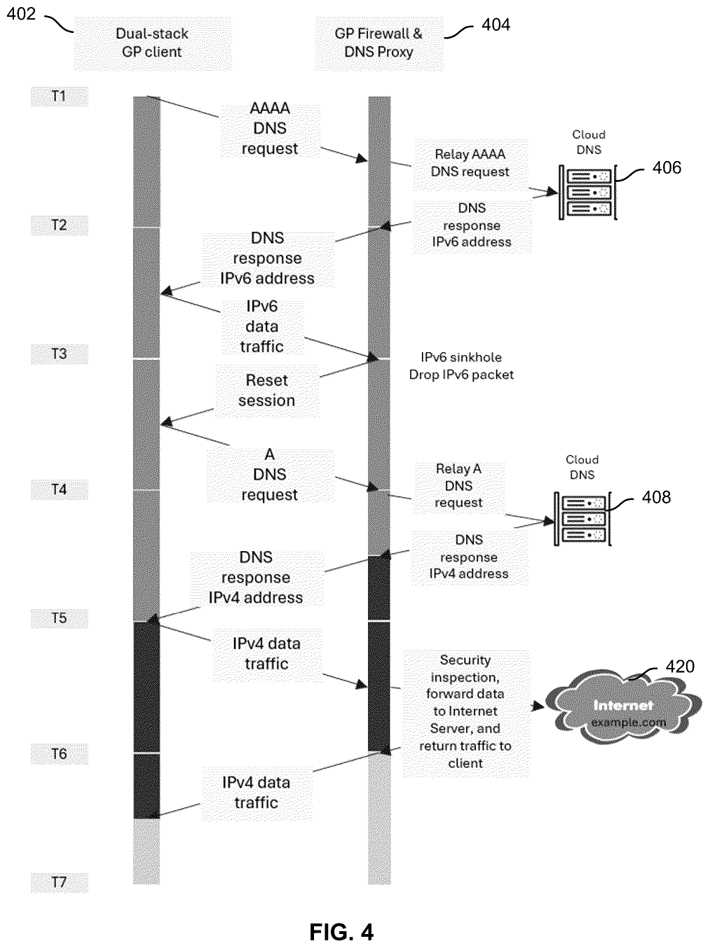

FIG. 4 is a diagram illustrating an example timeline of a network traffic pattern using a security service node having limited support for IPv6 traffic. For example, FIG. 4 illustrates an example timeline of network traffic in the network environment shown in FIG. 1. The shown example illustrates six time segments to handle network traffic involving IPv6 network traffic not fully supported for security examination at a network security node. In some embodiments, Dual-stack GP client 402 is IPv4/IPv6 client 104, GP firewall and DNS proxy 404 is MU GW 102, cloud DNS 406 is cloud DNS 106, and Internet server 420 is Internet server 120 of FIG. 1.

In the first time segment, dual-stack GP client 402 sends an IPv6 “AAAA” DNS request to GP firewall and DNS proxy 404. When GP Firewall and DNS proxy 404 receives the “AAAA” DNS request, it relays the “AAAA” DNS request to the cloud DNS 406. Cloud DNS 406 responds to the “AAAA” DNS request with a corresponding IPv6 address.

In the second time segment, GP firewall and DNS proxy 404 forwards the IPv6 address received from cloud DNS 406 to dual-stack GP client 402. When the IPv6 address is received, dual-stack GP client 402 initiates a data request using the IPv6 address. When the IPv6 data request is received/intercepted by GP firewall and DNS proxy 404, the packets in the IPv6 data request are dropped via sinkhole due to the security service node configuration not fully supporting security examination of IPv6 network traffic. In some embodiments, the security service node is configured to drop received IPv6 packets and reset the associated IPv6 session to cause an IPv4 session to be initiated instead. An example of the dropped packets has been previously described in conjunction with sinkhole 108 of FIG. 1.

In the third time segment, GP firewall and DNS proxy 404 notifies dual-stack GP client 402 that the IPv6 data traffic failed and to reset the associated IPv6 session. Since IPv6 data traffic failed, dual-stack GP client 402 initiates an IPv6 “A” DNS request instead of an IPv6 “AAAA” DNS request to GP firewall and DNS proxy 404.

In the fourth time segment, when GP firewall and DNS proxy 404 receives the IPv4 “A” DNS request from dual-stack GP client 402, the “A” DNS request is relayed to cloud DNS 408. Cloud DNS 408 responds by providing GP Firewall and DNS proxy 404 with an IPv4 address corresponding to the “A” DNS request. In some embodiments, cloud DNS 408 is the same DNS server as cloud DNS 406. Once GP firewall and DNS proxy 404 receives the IPv4 address, the IPv4 address is provided to dual-stack GP client 402.

In the fifth time segment, dual-stack GP client 402 initiates IPv4 data traffic using the IPv4 address received in the fourth time segment. IPv4 data traffic is received at GP firewall and DNS proxy 404 and a security inspection is performed on the data traffic. If the data traffic passes the security inspection, the data is forwarded to Internet server 420.

In the sixth time segment, any IPv4 data traffic received by GP firewall and DNS proxy 404 from Internet server 420 is analyzed to perform a security inspection and sent to dual-stack GP client 402 if a security issue is not detected. In some embodiments, the IPv4 data traffic includes packets of data storing a variety of information including but not limited to application data, transport data, network data, data link data, and physical data.

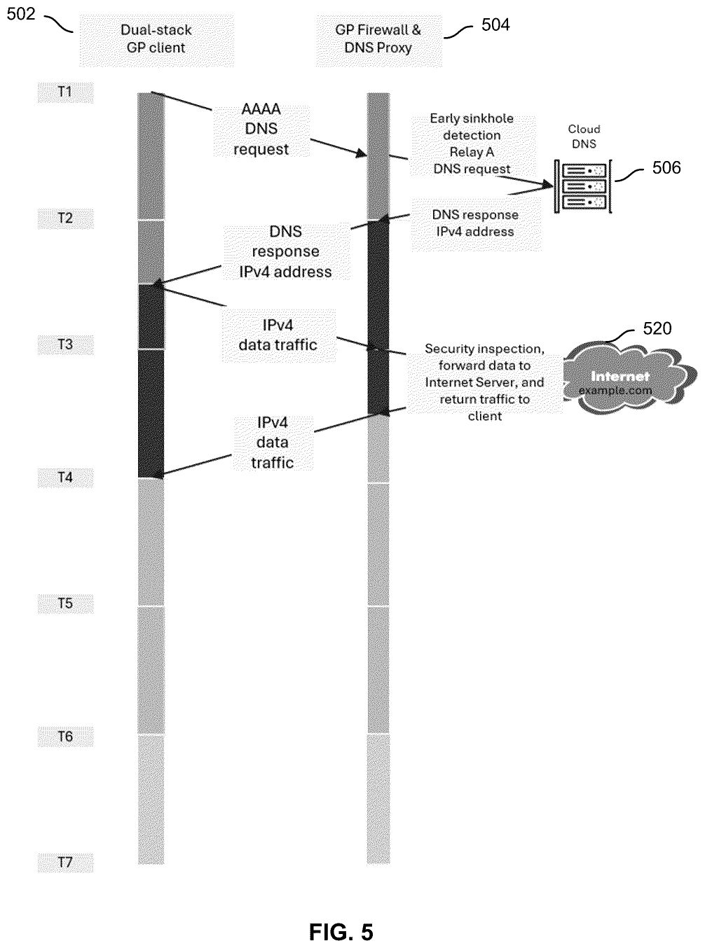

FIG. 5 is a diagram illustrating an example timeline for a cloud security solution at a security service node using a DNS proxy transformation to overcome limited support for IPv6. The example shown has three time segments. In some embodiments, GP firewall and DNS proxy 504 is part of a cloud security service node. In some embodiments, dual-stack GP client 502 is IPv4/IPv6 client 204 of FIG. 2 and IPv4/IPv6 client 302 of FIG. 3, GP firewall and DNS proxy 504 is MU GW 202 of FIG. 2 and FW DNS Proxy 304 of FIG. 3, cloud DNS 506 is cloud DNS 206 of FIG. 2 and cloud DNS 306 of FIG. 3, and Internet server 520 is Internet server 220 of FIG. 2 and IPv4/IPv6 server 320 of FIG. 3.

In the first time segment, dual-stack GP client 502 sends an IPv6 “AAAA” DNS request to GP firewall and DNS proxy 504. Once GP firewall and DNS proxy 504 receives the “AAAA” DNS request, the GP firewall and DNS proxy 504 detects that the DNS request is for IPv6, a protocol not supported for security examination at a security service node (e.g., using IPv6 will lead to the sinkhole of FIG. 1 being utilized to cause failure over to supported IPv4). In response to detecting the IPv6 request, GP firewall and DNS proxy 504 converts the IPv6 “AAAA” DNS request to an IPv4 “A” DNS request and relays the IPv4 “A” DNS request to cloud DNS 506. Cloud DNS 506 responds to the “A” DNS request by returning a corresponding IPv4 address to GP firewall and DNS proxy 504.

In the second time segment, dual-stack GP client 502 receives the IPv4 address from GP Firewall and DNS proxy 504. Once the IPv4 address is received, dual-stack GP client 502 can initiate IPv4 data traffic, and GP Firewall and DNS proxy 504 receives/intercepts the IPv4 data traffic directed to the IPV4 address.

In the third time segment, GP firewall and DNS proxy 504 performs a security inspection on the IPv4 data traffic and upon passing the security inspection, forwards the IPv4 data traffic to Internet server 520. IPv4 data traffic received from Internet server 520 by GP firewall and DNS proxy 504 is examined for security issues and returned to dual-stack GP client 502 if determined to be safe. In some embodiments, the IPv4 data traffic includes packets of data storing a variety of information including but not limited to application data, transport data, network data, data link data, and physical data.

Early detection of the IPv6 IP address DNS request to be used by a client being protected by a security service node (e.g., firewall) that does not support IPv6 traffic examination (e.g., IPv6 traffic is to be dropped in a sinkhole) and early translation of the IPv6 DNS request to a supported IPv4 DNS request speeds up network data traffic by proactively avoiding the use of the sinkhole and related delays. As described in conjunction with FIG. 4, dual-stack GP client 402 could only begin IPv4 data traffic in the fifth time segment of FIG. 4, while the IPv6 to IPv4 DNS request interception and translation by an active DNS proxy allows the dual-stack GP client to begin IPv4 data traffic in the second time segment of FIG. 5. Thus, the implementation of an active DNS proxy can significantly reduce the delay experienced by dual-stack GP client 502.

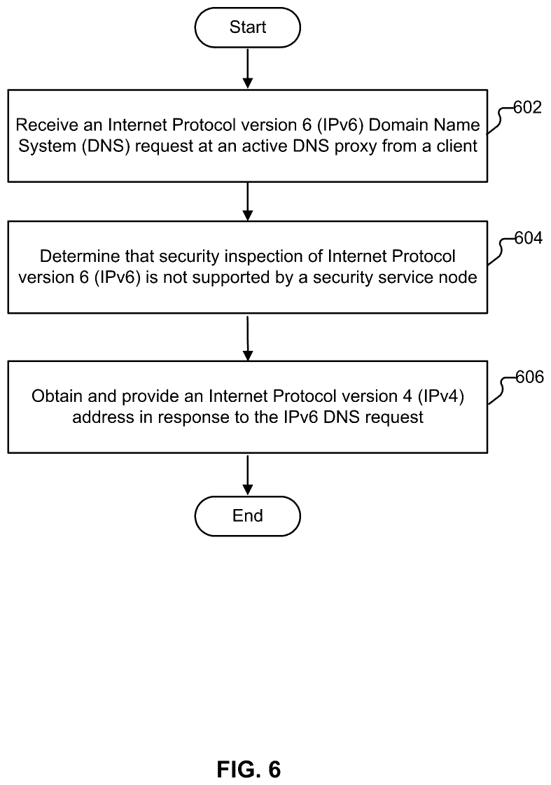

FIG. 6 is a flow diagram illustrating an embodiment for handling a DNS request for a protocol not supported for security inspection. For example, using the process of FIG. 6, a DNS proxy can receive/intercept a DNS request in a security inspection incompatible Internet Protocol version from a client and translate the DNS request to a protocol version compatible with security inspection to reduce delays in handling the security inspection incompatible Internet Protocol version. In some embodiments, the active DNS proxy converts a DNS request for an IPv6 address (e.g., security protocol incompatible version) to an IPv4 DNS request (e.g., security protocol compatible version) before forwarding the DNS request to a DNS server. In some embodiments, the process of FIG. 6 is executed by MU GW of 202 of FIG. 2 and/or FW DNS Proxy 304 of FIG. 3.

At 602, at an active Domain Name System (DNS) proxy, an Internet Protocol version 6 (IPv6) request from a client is received. For example, the DNS request is an IPv6 “AAAA” DNS request, indicating a request for an IP address in Internet Protocol version 6. In some embodiments, the DNS request is for a website or application data available via the Internet. In some embodiments, the client is using security software that protects the client's network connection. For example, the client has a VPN, firewall, or any other security software that acts as an intermediary between the client and the Internet.

At 604, it is determined that security inspection of Internet Protocol version 6 (IPv6) is not supported by the security service node. For example, the security service node has not been configured with functionality to filter and inspect IPv6 data traffic. As another example, the security service node has not been configured to detect, authenticate, or verify IPv6 IP addresses, leaving the client's device and data open to security risks such as malware. By detecting that a received/intercepted DNS request is requesting an IP address in a protocol version (e.g., IPv6) not supported for security inspection by the security service node, the use of the unsupported protocol version IP address can be prevented by returning a supported protocol version IP address (e.g., IPv4) instead in response to the unsupported protocol version IP address request. Examples of the security inspection include analysis for detection of various cyber-attacks including but not limited to denial-of-service attacks, distributed-denial-of-service attacks, malware, man-in-the-middle attacks, and DNS tunnelling. In some embodiments, determining that security inspection of Internet Protocol version 6 (IPv6) is not supported by the security service node includes comparing a protocol version of the requested IP address with a configuration, a setting, a version, a model, or a capabilities specification of the security service node to determine whether the protocol version of the requested IP address is supported for security inspection. In some embodiments, determining that security inspection of Internet Protocol version 6 (IPv6) is not supported by the security service node includes determining that a network communication made using an IP address of the requested protocol version (e.g., IPv6) is going to be dropped (e.g., via a sinkhole described in conjunction with FIGS. 1 and 4).

At 606, an Internet Protocol version 4 (IPv4) address is obtained and provided in response to the IPv6 DNS request. For example, an IPv4 address corresponding to a domain name in the IPv6 DNS request is obtained and provided. In some embodiments, the IPv6 DNS request includes an “AAAA” DNS request and the IPv4 DNS request includes an “A” DNS request. In some embodiments, the received IPv6 “AAAA” DNS request is translated into an IPv4 “A” DNS request and the IPv4 “A” DNS request is sent to a DNS server. For example, contents of the received IPv6 “AAAA” DNS request for a domain name are modified to request an IPv4 address for the same domain name instead. In some embodiments, the corresponding IPv4 address to the IPv4 “A” DNS request is obtained from the cache of the active DNS proxy. For example, the IPv4 address for the domain name of the received request was previously obtained from a DNS server during a previous query and was stored in the cache of the DNS proxy. In some embodiments, the corresponding IPv4 address to the IPv4 “A” DNS request is obtained from a DNS server, cloud DNS, or any other hardware or service that can map DNS requests to IP addresses. In some embodiments, the DNS server that returns the corresponding IPv4 address to an A DNS request is cloud DNS 106 of FIG. 1, cloud DNS 206 of FIG. 2, cloud DNS 306 of FIG. 3, cloud DNS 408 of FIG. 4, or cloud DNS 506 of FIG. 5. In some embodiments, the active DNS proxy caches the received IPv4 address.

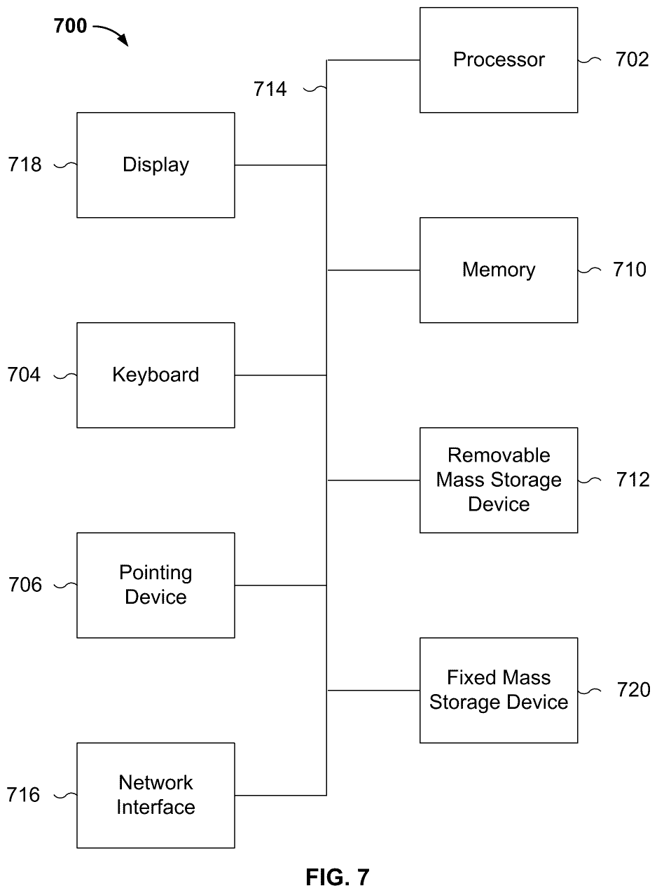

FIG. 7 is a functional diagram illustrating a programmed computer system for an active DNS proxy. As will be apparent, other computer system architectures and configurations can be utilized for performing related entity record resolution and entity resolution using machine learning models. Examples of computer system 700 include client 204 of FIG. 2 and one or more computers used to implement MU GW 202 of FIG. 2. Computer system 700, which includes various subsystems as described below, includes at least one microprocessor subsystem (also referred to as a processor or a central processing unit (CPU)) 702. For example, processor 702 can be implemented by a single-chip processor or by multiple processors. In some embodiments, processor 702 is a general purpose digital processor that controls the operation of the computer system 700. Using instructions retrieved from memory 710, the processor 702 controls the reception and manipulation of input data, and the output and display of data on output devices (e.g., display 718). In various embodiments, one or more instances of computer system 700 can be used to implement at least portions of the processes of FIGS. 2 through 6.

Processor 702 is coupled bi-directionally with memory 710, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 702. Also as is well known in the art, primary storage typically includes basic operating instructions, program code, data and objects used by the processor 702 to perform its functions (e.g., programmed instructions). For example, memory 710 can include any suitable computer-readable storage media, described below, depending on whether, for example, data access needs to be bi-directional or unidirectional. For example, processor 702 can also directly and very rapidly retrieve and store frequently needed data in a cache memory (not shown).

A removable mass storage device 712 provides additional data storage capacity for the computer system 700, and is coupled either bi-directionally (read/write) or unidirectionally (read only) to processor 702. For example, storage 712 can also include computer-readable media such as magnetic tape, flash memory, PC-CARDS, portable mass storage devices, holographic storage devices, and other storage devices. A fixed mass storage 720 can also, for example, provide additional data storage capacity. The most common example of mass storage 720 is a hard disk drive. Mass storages 712, 720 generally store additional programming instructions, data, and the like that typically are not in active use by the processor 702. It will be appreciated that the information retained within mass storages 712 and 720 can be incorporated, if needed, in standard fashion as part of memory 710 (e.g., RAM) as virtual memory.

In addition to providing processor 702 access to storage subsystems, bus 714 can also be used to provide access to other subsystems and devices. As shown, these can include a display monitor 718, a network interface 716, a keyboard 704, and a pointing device 706, as well as an auxiliary input/output device interface, a sound card, speakers, and other subsystems as needed. For example, the pointing device 706 can be a mouse, stylus, track ball, or tablet, and is useful for interacting with a graphical user interface.

The network interface 716 allows processor 702 to be coupled to another computer, computer network, or telecommunications network using a network connection as shown. For example, through the network interface 716, the processor 702 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 702 can be used to connect the computer system 700 to an external network and transfer data according to standard protocols. For example, various process embodiments disclosed herein can be executed on processor 702, or can be performed across a network such as the Internet, intranet networks, or local area networks, in conjunction with a remote processor that shares a portion of the processing. Additional mass storage devices (not shown) can also be connected to processor 702 through network interface 716.

An auxiliary I/O device interface (not shown) can be used in conjunction with computer system 700. The auxiliary I/O device interface can include general and customized interfaces that allow the processor 702 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 7 is but an example of a computer system suitable for use with the various embodiments disclosed herein. Other computer systems suitable for such use can include additional or fewer subsystems. In addition, bus 714 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving at an active Domain Name System (DNS) proxy, an Internet Protocol version 6 (IPv6) DNS request from a client;
determining that security inspection of Internet Protocol version 6 (IPv6) is not supported by a security service node; and
obtaining and providing an Internet Protocol version 4 (IPv4) address in response to the IPv6 DNS request.

2. The method of claim 1, wherein determining that IPv6 is not supported by the security service node includes determining that the security service node is configured to drop unsupported IPv6 packets.

3. The method of claim 1, wherein obtaining and providing the Internet Protocol version 4 (IPv4) address includes translating the IPv6 DNS request to an IPv4 DNS request and providing the IPv4 DNS request to a Domain Name System service.

4. The method of claim 3, wherein the IPv6 DNS request includes an “AAAA” DNS request and the IPv4 DNS request includes an “A” DNS request.

5. The method of claim 1, further comprising:
intercepting at the security service node, IPv4 data traffic for the IPv4 address;
performing a security inspection of the IPv4 data traffic; and
forwarding the IPv4 data traffic to the IPv4 address.

6. The method of claim 1, wherein the security service node includes a network gateway.

7. The method of claim 1, wherein the security service node includes a firewall or a secure web gateway.

8. The method of claim 1, wherein the security service node is configured to drop a received IPv6 packet and reset an associated IPv6 session to cause an IPv4 session to be initiated instead.

9. A system, comprising:
one or more processors configured to:
receive at an active Domain Name System (DNS) proxy, an Internet Protocol version 6 (IPv6) DNS request from a client;
determine that security inspection of Internet Protocol version 6 (IPv6) is not supported by a security service node; and
obtain and provide an Internet Protocol version 4 (IPv4) address in response to the IPv6 DNS request; and
a memory coupled to the one or more processors and configured to provide the one or more processors with instructions.

10. The system of claim 9, wherein determining that IPv6 is not supported by the security service node includes determining that the security service node is configured to drop unsupported IPv6 packets.

11. The system of claim 9, wherein obtaining and providing the Internet Protocol version 4 (IPv4) address includes translating the IPv6 DNS request to an IPv4 DNS request and providing the IPv4 DNS request to a Domain Name System service.

12. The system of claim 11, wherein the IPv6 DNS request includes an “AAAA” DNS request and the IPv4 DNS request includes an “A” DNS request.

13. The system of claim 9, wherein the one or more processors are further configured to:
intercept at the security service node, IPv4 data traffic for the IPv4 address;
perform a security inspection of the IPv4 data traffic; and
forward the IPv4 data traffic to the IPv4 address.

14. The system of claim 9, wherein the security service node includes a network gateway.

15. The system of claim 9, wherein the security service node includes a firewall or a secure web gateway.

16. The system of claim 9, wherein the security service node is configured to drop a received IPv6 packet and reset an associated IPv6 session to cause an IPv4 session to be initiated instead.

17. A computer program product embodied in a non-transitory computer readable medium and comprising computer instructions for:
receiving at an active Domain Name System (DNS) proxy, an Internet Protocol version 6 (IPv6) DNS request from a client;
determining that security inspection of Internet Protocol version 6 (IPv6) is not supported by a security service node; and
obtaining and providing an Internet Protocol version 4 (IPv4) address in response to the IPv6 DNS request.

18. The computer program product of claim 17, wherein determining that IPv6 is not supported by the security service node includes determining that the security service node is configured to drop unsupported IPv6 packets.

19. The computer program product of claim 17, wherein obtaining and providing the Internet Protocol version 4 (IPv4) address includes translating the IPv6 DNS request to an IPv4 DNS request and providing the IPv4 DNS request to a Domain Name System service.

20. The computer program product of claim 17, further comprising computer instructions for:
intercepting at the security service node, IPv4 data traffic for the IPv4 address;
performing a security inspection of the IPv4 data traffic; and
forwarding the IPv4 data traffic to the IPv4 address.
